(19) United States
(12) Patent Application Publication
(10) Pub. No.: US 2025/0216211 A1
(43) Pub. Date: Jul. 3, 2025

(54) METHOD FOR PROVIDING WIDGETS AND A NAVIGATION DEVICE FOR PERFORMING THE SAME

(71) Applicant: HYUNDAI AUTOEVER CORP., Seoul (KR)

(72) Inventors: Hee Eun Lee, Seoul (KR); Ji Young Han, Seoul (KR); Won Heung Jo, Seoul (KR); Esther Choi, Seoul (KR); Joo Ho Chae, Seoul (KR); Il Kyun Kim, Seoul (KR); Min Jeong Kim, Seoul (KR); Yeon Kyung Chung, Seoul (KR); Hwa Hyeon Hong, Seoul (KR); Rak Jun Sung, Seoul (KR)

(73) Assignee: HYUNDAI AUTOEVER CORP., Seoul (KR)

(21) Appl. No.: 18/987,167

(22) Filed: Dec. 19, 2024

(30) Foreign Application Priority Data
Jan. 2, 2024 (KR) 10-2024-0000230

(51) Int. Cl. G01C 21/36; G06F 9/451

(52) U.S. Cl. CPC G01C 21/36; G06F 9/451

(57) ABSTRACT

A method for providing widgets on a display of a navigation device includes obtaining information about recently executed applications from a user device of a user in a mobility apparatus equipped with the navigation device. The information about the recently executed applications includes execution order information about an order in which the recently executed applications have been executed in the user device. The method also includes determining a display arrangement sequence of widgets of the recently executed applications on a display of the navigation device, based on the execution order information. The method additionally includes displaying the widgets in a first area of the display of the navigation device, based on the determined display arrangement sequence. The first area is positioned at a position adjacent to a side of the display opposite to a driver seat of the mobility apparatus.

### CROSS-REFERENCE TO RELATED APPLICATION

This application claims the benefit of and priority to Korean Patent Application No. 10-2024-0000230, filed on Jan. 2, 2024, the entire contents of which are hereby incorporated herein by reference.

### BACKGROUND

### Field

The present disclosure relates to a method for providing widgets on a display of a navigation device and a navigation device for performing the method.

### Description of Related Art

Generally, a mobility apparatus may employ a navigation system equipped with a GPS (Global Positioning System) to identify a current location and a current moving speed of the mobility apparatus or to determine a moving speed of the mobility apparatus. The navigation system receives a radio wave indicating a latitude, a longitude, an altitude, etc. from a plurality of artificial satellites, calculates a current location of a moving object to identify the current location of the moving object, identifies a destination input by a user, and determines a moving route starting from the current location and arriving at the destination.

In this regard, the navigation system not only performs a function of providing a route for a user to arrive at a destination, but also performs various additional functions in association with a user device such as a smartphone or smart watch. For example, the navigation system may provide a widget of an application installed on the user device operating in association with the navigation system on a navigation screen. The user may manipulate the widget provided on the navigation screen to use functions or information provided by the application.

However, according to a conventional approach, the widgets of the applications are randomly placed at the navigation screen regardless of application usage history in the user device, resulting in poor usability.

### SUMMARY

A technical purpose to be achieved according to some embodiments of the present disclosure is to provide a method for providing an application widget on a navigation screen based on the user application usage information.

Another technical purpose to be achieved according to some embodiments of the present disclosure is to provide a method for displaying a widget of an application suitable for a navigation screen based on situation information.

The technical purposes of the present disclosure are not limited to the technical purposes mentioned above. Other technical purposes not mentioned may be clearly understood by those having ordinary skill in the art from descriptions set forth below.

According to an aspect of the present disclosure, a method for providing widgets is provided. The method may be performed by a navigation device. The method includes obtaining information about recently executed applications from a user device of a user in a mobility apparatus equipped with the navigation device. The information about the recently executed applications includes execution order information about an order in which the recently executed applications have been executed in the user device. The method also includes determining a display arrangement sequence of widgets of the recently executed applications on a display of the navigation device, based on the execution order information. The method additionally includes displaying the widgets in a first area of the display of the navigation device, based on the determined display arrangement sequence. The first area is positioned at a position adjacent to a side of the display opposite to a driver seat of the mobility apparatus.

In some embodiments, displaying the widgets in the first area may include displaying a first-order widget at a left or right side of the first area, based on user sitting position information.

In some embodiments, displaying the widgets in the first area may include displaying the first-order widget at the left side of the first area, based on the user sitting position information indicating that the user is sitting on the driver seat of the mobility apparatus.

In some embodiments, displaying the widgets in the first area may include displaying the first-order widget at the right side of the first area, based on the user sitting position information indicating that the user is sitting on a passenger seat of the mobility apparatus.

In some embodiments, displaying the widgets in the first area may include adding a plurality of widgets respectively corresponding to a plurality of slots arranged in the first area to the plurality of slots, respectively.

In some embodiments, the first area may include at least one slot arranged in a horizontal direction.

In some embodiments, the method may further include obtaining situation information of the mobility apparatus and displaying widgets of recently executed applications associated with the situation information of the mobility apparatus in a second area different from the first area.

In some embodiments, the situation information of the mobility apparatus may include at least one of driving status information of the mobility apparatus, destination information of the mobility apparatus, position information of the mobility apparatus, status information of the mobility apparatus, or user sitting position information of the mobility apparatus.

In some embodiments, displaying the widgets in the second area may include obtaining frequency information on a frequency at which each of the recently executed applications associated with the situation information of the mobility apparatus has been executed in the user device and displaying the widgets of the recently executed applications associated with the situation information of the mobility apparatus in the second area, based on a display arrangement sequence determined based on the frequency information.

In some embodiments, the second area may be positioned at a position adjacent to a side of the display adjacent to the driver seat of the mobility apparatus.

In some embodiments, the second area may include at least one slot arranged in a vertical direction.

According to another aspect of the present disclosure, another method for providing widgets is provided. The method may be performed by a navigation device. The method includes obtaining information about recently executed applications from a user device of a user in a mobility apparatus equipped with the navigation device. The information about the recently executed applications includes execution frequency information on a frequency at which each of the recently executed applications has been executed in the user device. The method also includes determining a display arrangement sequence of widgets of the recently executed applications on a display of the navigation device, based on the execution frequency information. The method additionally includes displaying the widgets in a first area of the display of the navigation device, based on the determined display arrangement sequence, wherein the first area is positioned at a position adjacent to a side of the display opposite to a driver seat of the mobility apparatus.

According to another aspect of the present disclosure, a navigation device is provided. The navigation device comprises a processor and a memory coupled to the processor, the memory configured to store instructions thereon. When the instructions are executed by the processor, the instructions cause the processor to perform operations. The operations include an operation of obtaining information about recently executed applications from a user device of a user in a mobility apparatus equipped with the navigation device. The information about the recently executed applications includes execution order information about an order in which the recently executed applications have been executed in the user device. The operations also include an operation of determining a display arrangement sequence of widgets of the recently executed applications on a display of the navigation device, based on the execution order information. The operations additionally include an operation of displaying the widgets in a first area of the display of the navigation device, based on the determined display arrangement sequence. The first area is positioned at a position adjacent to a side of the display opposite to a driver seat of the mobility apparatus.

In some embodiments, the operation of displaying of the widgets in the first area may include an operation of displaying a first-order widget at a left or right side of the first area, based on user sitting position information.

In some embodiments, the operation of displaying of the widgets in the first area may include an operation of displaying the first-order widget at the left side of the first area, based on the user sitting position information indicating that the user is sitting on the driver seat of the mobility apparatus.

In some embodiments, the operation of displaying of the widgets in the first area may include an operation of displaying the first-order widget at the right side of the first area, based on the user sitting position information indicating that the user is sitting on a passenger seat of the mobility apparatus.

In some embodiments, the operation of displaying of the widgets in the first area may include an operation of adding a plurality of widgets respectively corresponding to a plurality of slots arranged in the first area to the plurality of slots, respectively.

In some embodiments, when the instructions are executed by the processor, the instructions may cause the processor to further perform an operation of obtaining situation information of the mobility apparatus and an operation of displaying widgets of recently executed applications associated with the situation information of the mobility apparatus in a second area different from the first area.

In some embodiments, the situation information of the mobility apparatus may include at least one of driving status information of the mobility apparatus, destination information of the mobility apparatus, position information of the mobility apparatus, status information of the mobility apparatus, or user sitting position information of the mobility apparatus.

In some embodiments, the operation of displaying of the widgets in the second area may include: an operation of obtaining frequency information on a frequency at which each of the recently executed applications associated with the situation information of the mobility apparatus has been executed in the user device and an operation of displaying the widgets of the recently executed applications associated with the situation information of the mobility apparatus in the second area, based on a display arrangement sequence determined based on the frequency information.

### BRIEF DESCRIPTION OF DRAWINGS

The above and other aspects and features of the present disclosure should become more apparent from the detailed description below with reference to the accompanying drawings, in which:

FIG. 1 illustrates an environment in which a navigation device according to one embodiment of the present disclosure may be used;

FIGS. 2 and 3 are diagrams for illustrating an area where a widget is displayed on a display of a navigation device, according to some embodiments of the present disclosure;

FIG. 4 is a flowchart for illustrating a method for providing a widget according to an embodiment of the present disclosure;

FIGS. 5 and 6 are diagrams illustrating an example in which a widget is displayed in a first area on a display, according to one embodiment of the present disclosure;

FIG. 7 is a flowchart of operations that may be performed after operations described with reference to FIG. 4, according to an embodiment of the present disclosure;

FIGS. 8-10 are diagrams illustrating a widget displayed in a second area on a display, according to one embodiment of the present disclosure;

FIG. 11 is a flowchart illustrating a method for providing a widget, according to another embodiment of the present disclosure; and

FIG. 12 is a block diagram illustrating a hardware configuration of a computing device, according to an embodiment of the present disclosure.

### DETAILED DESCRIPTIONS

Hereinafter, embodiments of the present disclosure are described with reference to the accompanying drawings. Advantages and features of the present disclosure and methods of accomplishing the same may be understood more readily by reference to the following detailed description of some embodiments and the accompanying drawings. The present disclosure may, however, be embodied in many different forms and should not be construed as being limited to the embodiments set forth herein. Rather, these embodiments are provided to make this disclosure thorough and complete and to fully convey the concept of the disclosure to those having ordinary skill in the art. The scope of the present disclosure is defined by the appended claims and equivalents thereof.

In adding reference numerals to the components of each drawing, it should be noted that the same reference numerals are assigned to the same components as much as possible even when the components are shown in different drawings. In addition, in the following description, when it was determined that a detailed description of a related well-known configuration or function may obscure the gist of the present disclosure, the detailed description thereof has been omitted.

Unless otherwise defined, all terms used in the present specification (including technical and scientific terms) may be used in a sense that can be commonly understood by those having ordinary skill in the art to which the present disclosure pertains. In addition, the terms defined in the commonly used dictionaries should not be ideally or excessively interpreted unless they are specifically defined in the present disclosure. The terminology used herein is for the purpose of describing particular embodiments only and is not intended to be limiting of the present disclosure. In this specification, the singular also includes the plural unless specifically stated otherwise in the present disclosure.

In addition, in describing the component of the present disclosure, terms, such as first, second, A, B, (a), (b), may be used. These terms are only for distinguishing the components from other components, and the nature or order of the components is not limited by the terms. If a component is described as being “connected,” “coupled,” or “contacted” to another component, the component may be directly connected to or contacted with the other component, but it should be understood that another component also may be “connected,” “coupled” or “contacted” between the component and the other component.

When a component, device, module, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail with reference to the accompanying drawings.

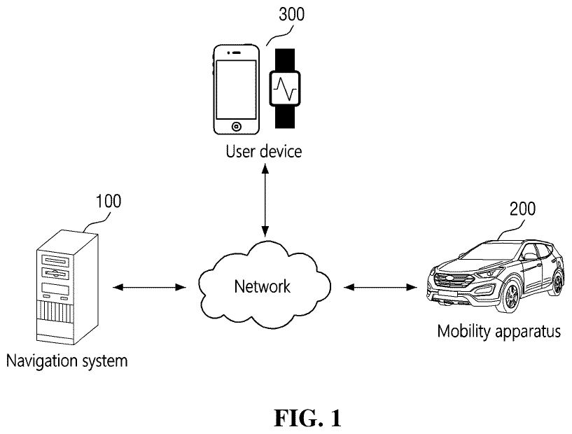

FIG. 1 illustrates an environment in which a navigation device according to one embodiment of the present disclosure may be used. As illustrated in FIG. 1, a navigation device 100 may interact with a mobility apparatus 200 and a user device 300 to implement a widget providing a method according to some embodiments of the present disclosure.

The navigation device 100 and the mobility apparatus 200 are illustrated as separate systems in FIG. 1. However, the present disclosure is not limited thereto. For example, in some embodiments, the navigation device 100 and the mobility apparatus 200 may be integrated into a single system in a stand-alone manner. In this case, it may be understood that operations performed in the navigation device 100 may be performed in the mobility apparatus 200.

According to one embodiment of the present disclosure, the navigation device 100 may obtain information about an application from the user device 300 of a user getting into the mobility apparatus 200. For example, the navigation device 100 may obtain information about a recently executed application from the user device 300. In an embodiment, the information about the recently executed application may include information related to execution in the user device 300. For example, the information about the recently executed application may include information related to execution history, such as execution order information about an order in which the recently executed applications were executed in the user device 300, execution frequency information about a frequency at which each of the recently executed applications was executed in the user device 300.

According to one embodiment of the present disclosure, the navigation device 100 may determine a display arrangement sequence of widgets of the recently executed applications using the execution order information about the order in which the recently executed applications were executed in the user device 300. For example, the widget of the most recently executed application in the user device 300 may be determined to have a first arrangement order. As another example, the widget of the most frequently executed application in the user device 300 may be determined to have a first arrangement order.

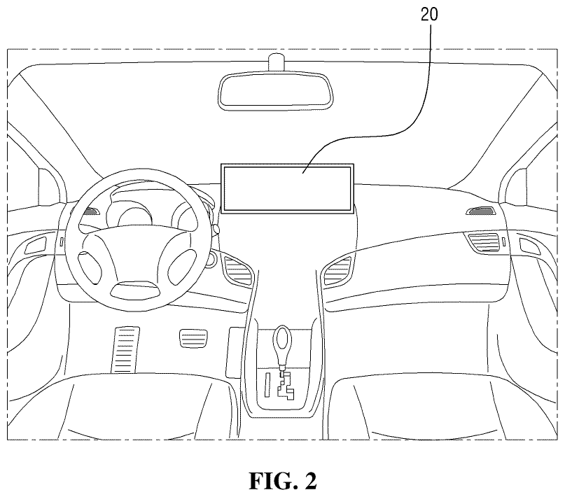

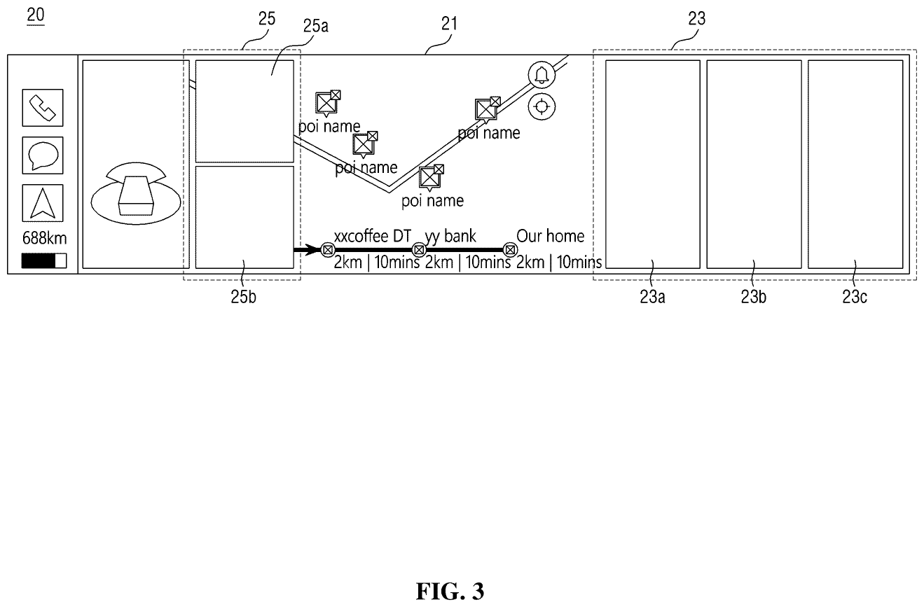

According to one embodiment of the present disclosure, the navigation device 100 may display the widgets on a first area of the display of the navigation device 100 according to the determined display arrangement sequence. In an embodiment, the first area may be an area on the display formed adjacent to a side opposite to the driver seat of the mobility apparatus. An example of the first area, according to some embodiments, is described in more detail below with reference to FIG. 2 and FIG. 3.

According to one embodiment of the present disclosure, the navigation device 100 may display the widget of the recently executed application associated with the situation information of the mobility apparatus on a second area different from the first area. In an example, the widget of the recently executed application associated with the situation information of the mobility apparatus may be preset by the user. As another example, the widget of the recently executed application associated with the situation information of the mobility apparatus may be determined based on the user's usage intention and the situation information of the mobility apparatus. For example, the application associated with the situation information where the destination is set to home may be a home IOT application, an OTT application, a market application, or an SNS application. In another example, the application associated with the situation information where the destination is set to a work place may be a mail application, a schedule application, a coffee order application, a breakfast order application, an OTT application, or an SNS application.

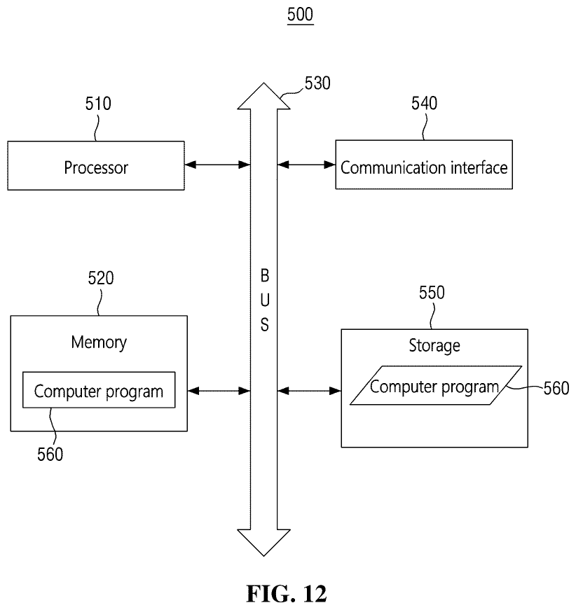

The navigation device 100 according to an embodiment of the present disclosure may be implemented on at least one computing device. For example, all functions of the navigation device 100 may be implemented on one computing device. Alternatively, some functions of the navigation device 100 may be implemented on a first computing device and the remaining functions thereof may be implemented on a second computing device. Alternatively, a specific function of the navigation device 100 may be implemented on a plurality of computing devices. The computing device may include any device equipped with a computing means and a communication means. An embodiment in which the navigation device 100 is embodied as a computing device is described in more detail below with reference to FIG. 12.

The user device 300 may be any personal computing device used by a user riding in the mobility apparatus 200. For example, the user device 300 may include a smartphone, a smartwatch, a tablet, a desktop, a laptop, etc. However, the present disclosure is not limited thereto, and the user device 300 may be embodied as any computing device equipped with a computing means and a communication means. As described above, the navigation device 100 may communicate with the user device 300 and may obtain the application information from the user device 300.

Furthermore, the components as illustrated in FIG. 1 may communicate with each other through a network. For example, the network may be embodied as any type of wired/wireless network such as a Local Area Network (LAN), a Wide Area Network (WAN), a mobile radio communication network, and/or Wibro (Wireless Broadband Internet). Furthermore, the navigation device 100, the mobility apparatus 200, and the user device 300 as illustrated in FIG. 1 may communicate with each other through a network to constitute a single computing system.

FIG. 2 and FIG. 3 are diagrams for illustrating an area where a widget is displayed on a display of the navigation device, according to embodiments of the present disclosure. FIG. 2 and FIG. 3 illustrate a case where the mobility apparatus is a vehicle.

As illustrated in FIG. 2, a display 20 of the navigation device 100 may be installed on a center area (e.g., dashboard, center fascia) in front of a front seat of the mobility apparatus. For example, the display 20 may have a wide shape extending from a side adjacent to the driver seat to a side adjacent to a passenger seat, and may be installed in a location at which the display 20 does not interfere with the driver driving.

Referring to FIG. 3, when the navigation device 100 operates, a map may be displayed on the display 20. For example, the map may be displayed on an entire area of the display 20. Alternatively, the map may be displayed on a partial area of the display 20. For example, the map may be displayed on an area excluding a first area 23 on the display 20.

The first area 23 may be an area of the display 20 adjacent to a side opposite to the driver seat of the mobility apparatus. For example, the first area 23 may be an area of the display 20 formed at the side opposite to the side adjacent to the driver seat, i.e., at the side adjacent to the passenger seat.

In one embodiment, the first area 23 may include a plurality of slots in which widgets of the applications are displayed. For example, the first area 23 may include three slots 23a, 23b, and 23c arranged side by side in the left-right direction. An example scheme in which the widget of the application is displayed is as follows. The widget of the application may be displayed in the first area in a scheme in which one widget is added to one slot. In one example, the number of slots or a size of the slot may vary according to the number of widgets or the size of the widget added to the slot, or may vary according to the user's settings.

A second area 25 may be an area of the display 20 formed adjacent to the side adjacent to the driver seat of the mobility apparatus. For example, the second area may be a left partial area 21 (in FIGS. 2 and 3) around an area in which the map of the display 20 is displayed. The second area 25 may be smaller than the first area 23, and accordingly, only key information may be displayed on the widget displayed in the second area 25.

In one embodiment, the second area 25 may include a plurality of slots in which widgets of the applications are displayed. For example, the second area 25 may include two slots 25a and 25b arranged in a vertical direction. In one example, the number of slots or the size of the slot may vary according to the number of widgets or the size of the widget added to the slot, or may vary according to the user's settings. For example, up to four widget slots may be arranged in the second area 25.

A configuration and an operation of the navigation device 100 according to an embodiment are described above with reference to FIGS. 1-3. The embodiments as described above may be understood in more detail with reference to other embodiments as described below. Furthermore, the technical ideas that may be understood based on the embodiments as described above may be applied to other embodiments as described below, unless otherwise specified.

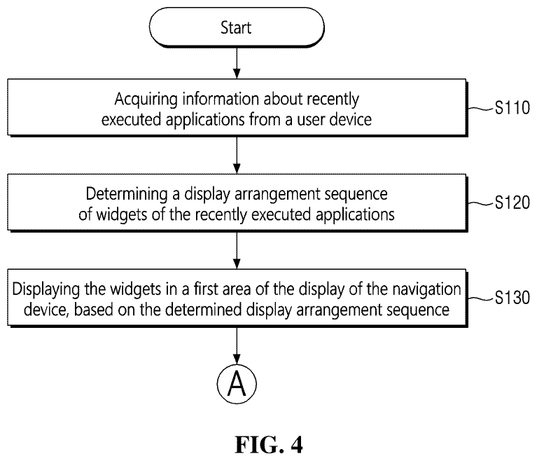

Hereinafter, a widget providing method according to embodiments of the present disclosure is described with reference to FIGS. 4-10. It may be understood that steps described in some flowcharts are performed by the navigation device 100 as described with reference to FIG. 1 in following descriptions unless otherwise stated. However, for the convenience of description, description about a subject that performs each step may be omitted.

FIG. 4 is a flowchart for illustrating a widget providing method according to an embodiment of the present disclosure. However, this is only an example embodiment for achieving the purpose of the present disclosure. It should be understood that some steps may be added or deleted as needed.

In an operation S110, information about a recently executed application may be obtained from a user device. In an embodiment, the user device may be a personal computing device used by a user in (e.g., a user getting into) a mobility apparatus equipped with a navigation device. In various embodiments, the user in (e.g., the user getting into) the mobility apparatus may include not only the driver getting into the driver seat of the mobility apparatus, but also other passengers. For example, the user in (e.g., the user getting into) the mobility apparatus may be a user sitting on the passenger seat.

In one embodiment, the information about the recently executed application obtained from the user device may include information about an application usage history in the user device. For example, the information about the recently executed application may include execution order information about the order in which the recently executed applications were executed in the user device. Thus, information about an application that the user last used before the user rides in the mobility apparatus may be obtained.

In an operation S120, the display arrangement sequence of the widgets of the recently executed applications may be determined using the execution order information obtained in the operation S110. For example, the display arrangement sequence of the widgets of the recently executed applications may be determined based on the order in which the recently executed applications were executed in the user device.

In an operation S130, the widgets may be displayed in the first area of the display of the navigation device according to the display arrangement sequence determined in the operation S120. As described above with reference to FIGS. 2 and 3, the first area may be an area of the display formed adjacent to the side opposite to the driver seat of the mobility apparatus.

In an example, the widgets may be displayed in the first area in a scheme in which each widget is added to each slot of the first area. In this regard, the number of widgets corresponding to the number of slots of the first area may be displayed. For example, when the first area has two slots, the widget of the most recently executed application on the user device (i.e., the widget of the application last used by the user) and the widget of the application executed before the most recently executed application may be displayed in the first area. The number of slots in the first area, and, accordingly, the number of widgets displayed in the first area, may vary according to the user's settings or may vary based on a size of the display of the navigation device.

In an example, a plurality of slots may be arranged side by side in the left-right direction in the first area. The widget of the most recently executed application may be added to the leftmost or rightmost slot among the plurality of slots. Then, the widget of the next recently executed application may be added to the next leftmost or rightmost slot. However, the present disclosure is not limited thereto. For example, the slots in the first area may be arranged side by side vertically, and, accordingly, the widgets of the applications may be sequentially arranged in a direction from top to bottom.

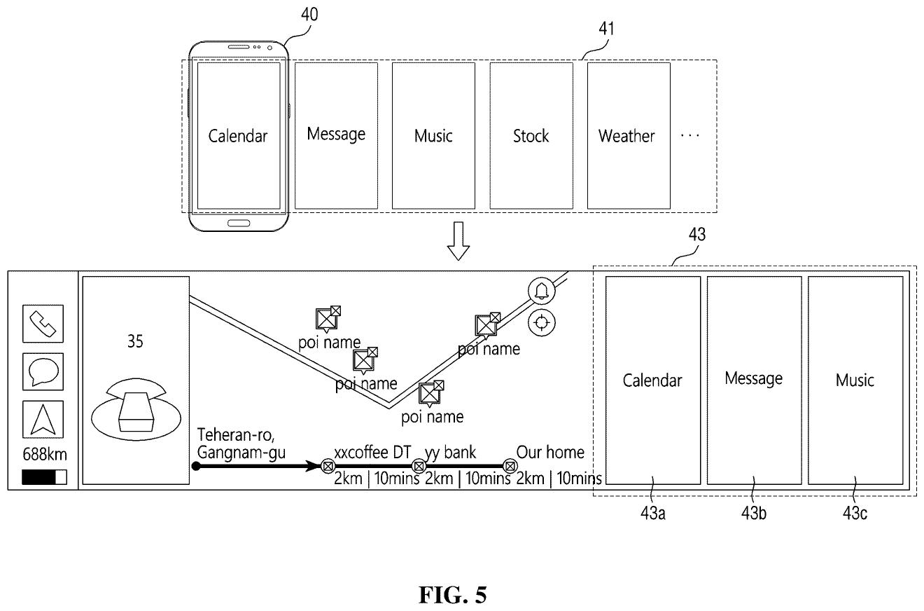

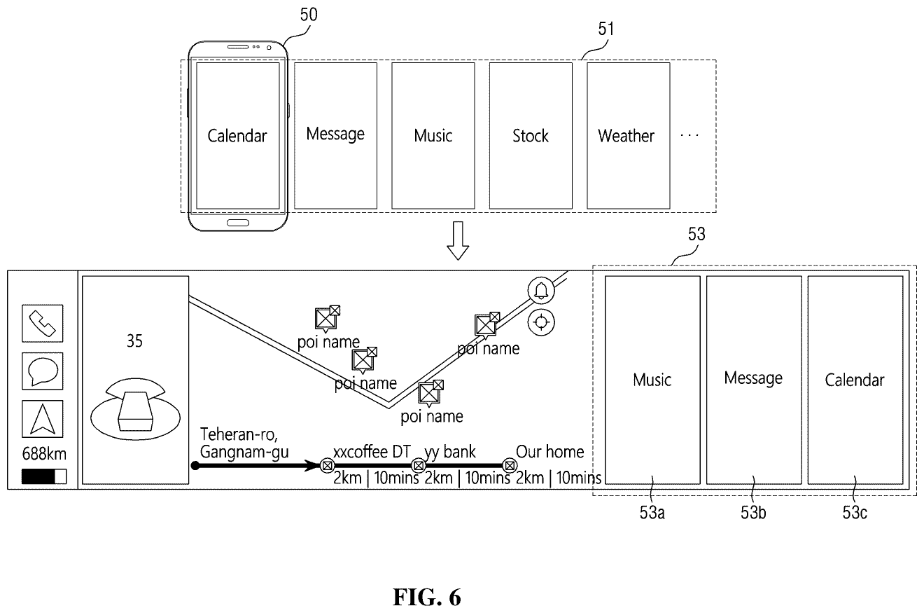

In one embodiment, a location where a first-order widget is displayed may be determined based on the user sitting position information. For example, when the user sits on the driver seat, the first-order widget, i.e., the widget of the most recently used application, may be placed at the left side of the first area. In another example, when the user sits on the passenger seat, the first-order widget, i.e., the widget of the most recently used application may be placed at the right side of the first area. In other words, the widget of the most recently used application may be displayed in a location closer to the user. This is described in more detail below with reference to FIGS. 5 and 6.

FIGS. 5 and 6 are diagrams showing an example in which a widget is displayed in the first area on the display according to one embodiment of the present disclosure.

FIG. 5 shows that while the navigation device operates in association with the user device of the user sitting on the driver seat, the navigation device displays the widgets of the recently executed applications in the first area according to the order in which they were executed in the user device.

Specifically, information about the order in which recently executed applications 41 are executed in a user device 40 may be obtained. Based on the obtained execution order information, the widgets of the recently executed applications may be displayed in a first area 43 according to the execution order. For example, the obtained execution order information may indicate that the most recently executed application in the user device 40 is an application related to a calendar, the application executed before the application related to the calendar is an application related to a message, and the application executed before the application related to the message is an application related to a music. Thus, the display arrangement sequence of the widgets of the recently executed applications may be determined based on the execution order information. Accordingly, the display arrangement sequence may be determined in the order of the widget of the calendar application, the widget of the message application, and the widget of the music application, and each widget may be displayed in the first area according to the determined display arrangement sequence. In an embodiment, based on the sitting position information indicating that the user sits on the driver seat, the widget of the calendar application as the first order widget may be added to a left slot 43a of the first area.

FIG. 6 shows that while the navigation device operates in association with the user device of the user sitting on the passenger seat, the navigation device displays the widgets of the recently executed applications in the first area according to the order in which they were executed in the user device. As an example, it is assumed that the execution order information about the order in which recently executed applications 51 are executed in a user device 50 is the same as that in the example of FIG. 5. In other words, the display arrangement sequence of the widgets of the applications may be the same as that in the example of FIG. 5. However, the sitting position information in FIG. 6 is different from that in FIG. 5, such that the location to which the widget of the first order is added may be different from that in FIG. 5. Specifically, based on the sitting position information indicating that the user sits on the passenger seat, the widget of the calendar application as the first order widget may be added to a right slot 53c of the first area.

In this way, in an embodiment, the widget of the first order may be added to the first area adjacent to the user, such that information on the application that the user most recently used may be provided to the user more effectively.

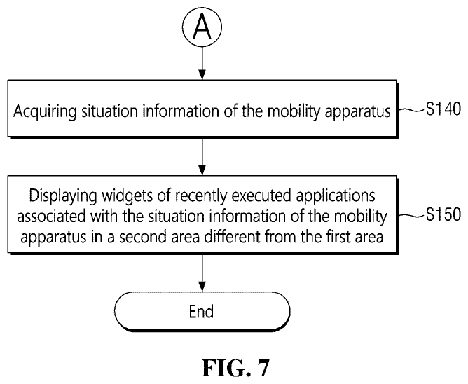

The operations for providing the widget to the first area on the display of the navigation device, according to an embodiment, are described above with reference to FIGS. 4-6. Next, operations for providing a widget to the second area that is different from the first area, according to an embodiment, are described below with reference to FIGS. 7-10.

FIG. 7 is a flowchart of operations that may be performed following the operations described with reference to FIG. 4. Hereinafter, operations for providing the widget to the second area are described with reference to FIG. 7.

In an operation S140, situation information of the mobility apparatus may be obtained. The situation information of the mobility apparatus may include driving status information of the mobility apparatus, destination information of the mobility apparatus, position information of the mobility apparatus, status information of the mobility apparatus, sitting position information of the mobility apparatus, etc. For example, the driving status information of the mobility apparatus may include information on status after getting into the vehicle and before driving, information on status while the vehicle is driving, information on status while the vehicle stops, and information on status while the vehicle is parking. In another example, the destination information of the mobility apparatus may include set destination information, stopover information, destination arrival time information, route information to the destination, etc.

In an operation S150, a widget of an application associated with the situation information of the mobility apparatus obtained in the operation S140 may be displayed in the second area. As described above with reference to FIGS. 2 and 3, the second area may be an area of the display formed adjacent to the driver seat of the mobility apparatus.

In one embodiment, the application associated with the situation information may be at least one of the applications recently executed in the user device. For example, the application associated with the situation information may be a specific application preset in response to the situation information. In another example, the application associated with the situation information may be an application that provides information or services expected to be needed by the user under the situation information.

In an embodiment, when first situation information is obtained, a widget of an application associated with the first situation information may be displayed in the second area. When the second situation information is obtained, a widget of an application associated with the second situation information may be displayed in the second area. In this regard, at least one of the applications associated with the first situation information may be different from the application associated with the second situation information.

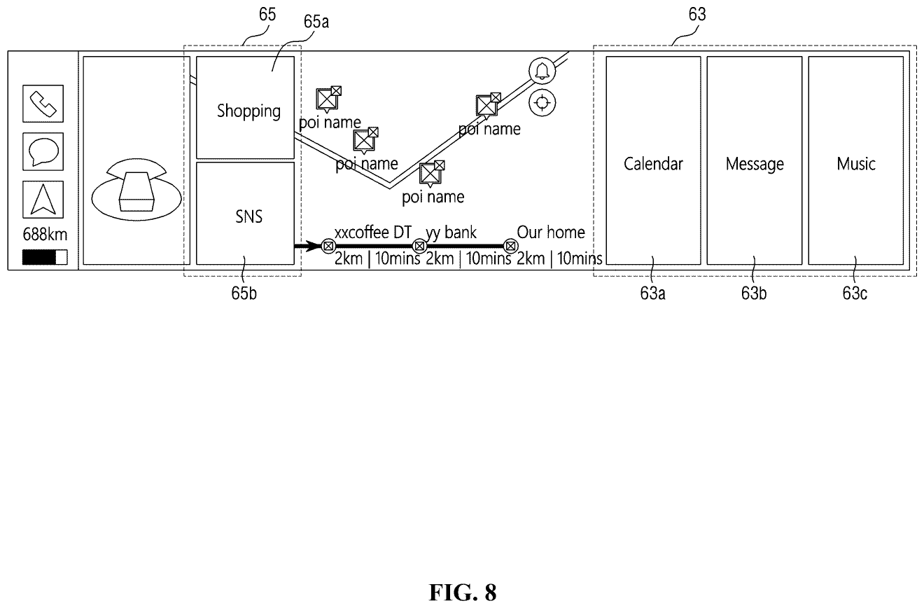

Hereinafter, with reference to FIGS. 8-10, the widget of the application displayed in the second area based on the obtained situation information, according to an embodiment, is described.

FIGS. 8 to 10 are diagrams showing an example in which a widget is displayed in the second area of the display according to an embodiment of the present disclosure.

FIG. 8 illustrates a case where situation information indicating that the user has gotten into the mobility apparatus but does not drive the mobility apparatus is obtained. The application associated with the situation information indicating that the user has gotten into the mobility apparatus but does not drive the mobility apparatus may be an application that is determined to have been last executed on the user device. For example, when the application that the user last used before the user gets into the vehicle is a shopping-related application, the widget of the shopping-related application may be added to a slot 75a located at an upper portion of the second area 75. Accordingly, the user may continue to receive information provided by the application that the user last used before getting into the mobility apparatus.

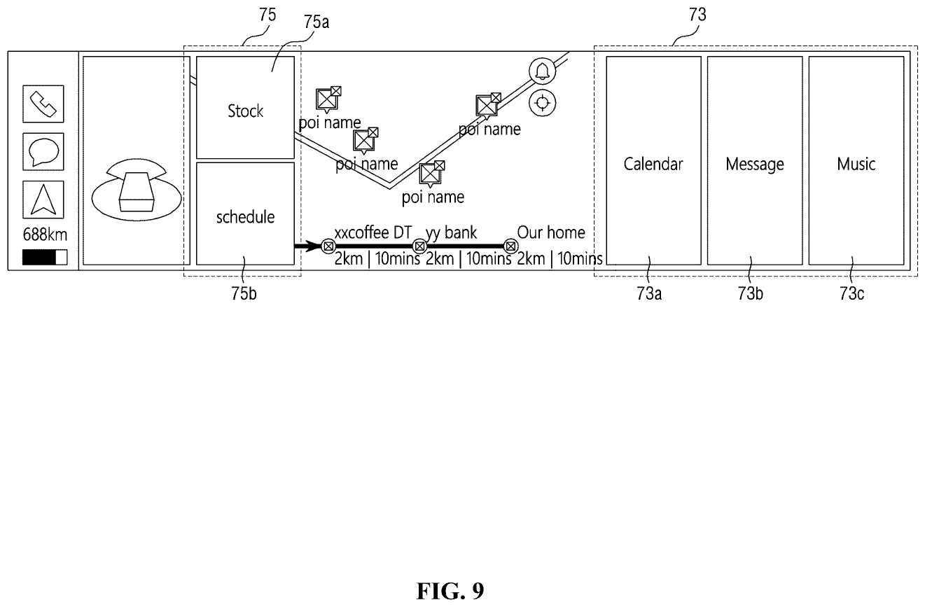

FIG. 9 illustrates a case where situation information indicating that the mobility apparatus is driving is obtained. The application associated with the situation information that the mobility apparatus is driving may be an application including notification information. For example, the application including notification information may be a schedule application, a stock application, or an SNS application.

In one example, for the driver safety while the vehicle is driving, it is desirable to minimize the number of the widgets displayed on the display or the frequency at which the widget is displayed. Therefore, the application associated with the situation information indicating that the mobility apparatus is driving may be displayed when a specific event occurs in the application. For example, when the application associated with the situation information indicating that the mobility apparatus is driving is the schedule application, the widget of the schedule application may be displayed in the second area when a schedule time is approaching (e.g., 1 hour ago). In another example, when the application associated with the situation information indicating that the mobility apparatus is driving is the stock application, the widget of the stock application may be displayed in the second area when a price of a specific stock set by the user changes.

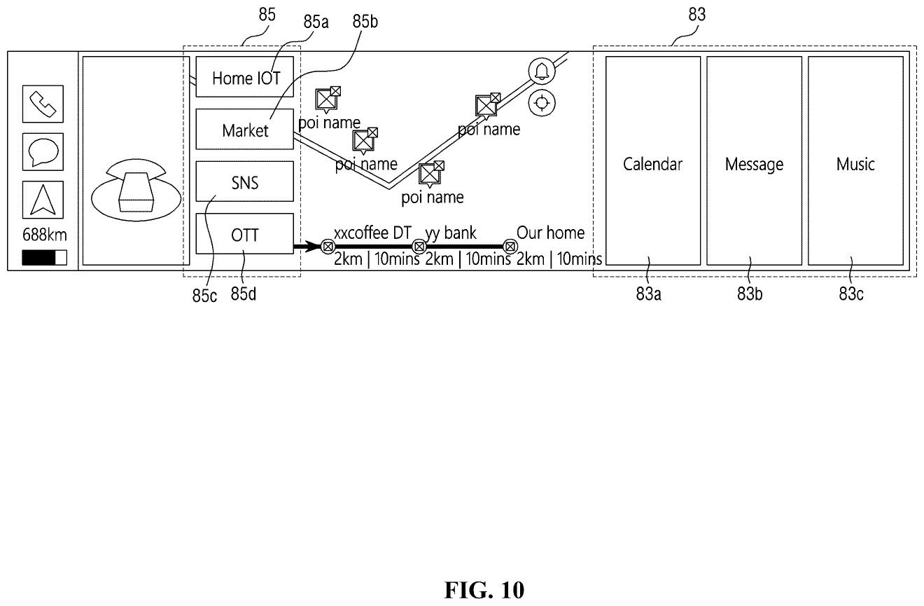

FIG. 10 shows an example of a case where situation information is obtained that indicates that the destination of the mobility apparatus is set to a home. The application associated with the situation information which indicates that the destination of the mobility apparatus is set to the home may be a home IOT application, a market application, an SNS application, or an OTT application. In this regard, when there are a plurality of applications associated with the situation information which indicates that the destination of the mobility apparatus is set to the home, a widget of a frequently used application among the plurality of applications may be beneficially displayed. In other words, the widget of the application identified as having the highest execution frequency on the user device may be displayed in the top slot 85a among the slots of the second area.

The operations for providing the widget to the second area on the display of the navigation device, according to an embodiment, are described above with reference to FIGS. 7-10. In this regard, a configuration in which the operations for providing the widget to the second area are performed after the operations for providing the widget to the first area has described above. However, this is only an example of the present disclosure, and the operations for providing the widget to the first area and the operations for providing the widget to the second area may be performed simultaneously. Furthermore, the widget may be provided to only one of the first area and the second area.

In one example, in this embodiment, the configuration in which the display arrangement sequence of the widgets displayed in the first area is determined based on the execution order information of the applications related thereto on the user device has been described above. However, the present disclosure is not limited thereto, and the display arrangement sequence of the widgets displayed in the first area may be determined based on other criteria. For example, the display arrangement sequence of the widgets displayed in the first area may be determined using execution frequency information on the frequency at which the recently executed application is executed on the user device.

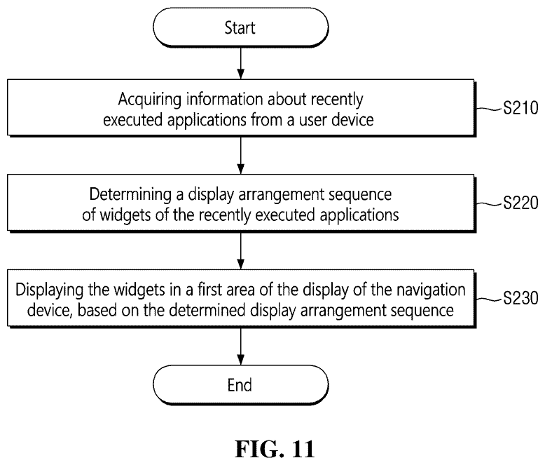

FIG. 11 is a flowchart for illustrating a widget providing method according to another embodiment of the present disclosure. However, this is only an example embodiment for achieving the purpose of the present disclosure, and some steps may be added or deleted as needed. For reference, descriptions duplicate with those about the previous embodiments have been omitted.

In an operation S210, information on recently executed applications may be obtained from the user device. In one embodiment, the information on recently executed applications as obtained from the user device may include information on application usage history on the user device. For example, the information about the recently executed application may include execution frequency information about the frequency at which the recently executed application is executed on the user device. Thus, information about the application frequently used by the user may be obtained.

In an operation S220, the display arrangement sequence of the widgets of the recently executed applications may be determined using the execution frequency information obtained in the operation S210. For example, the display arrangement sequence of the widgets of the recently executed applications may be determined based on values of frequencies at which the recently executed applications related thereto are respectively executed on the user device.

In an operation S230, the widgets may be displayed on the first area of the display of the navigation device based on the display arrangement sequence determined in the operation S220. For example, the widget of the application that the user uses most frequently may be added to the left or right slot of the first area. The display location of the widget of the application that the user uses most frequently may be determined based on the user sitting position information. This has been described in detail in the previous embodiment, and thus, the descriptions thereof has been omitted herein.

In one example, in this embodiment, it is described that widget is displayed in the first area based on the frequency at which the application related thereto is executed. However, as in the previously described embodiment, the widget may also be displayed in the second area based on the frequency at which the application related thereto is executed.

The methods according to the embodiments of the present disclosure described above may be performed via execution of a computer program implemented using a computer-readable code. The computer program may be transmitted from the first computing device to the second computing device through a network such as the Internet and may be installed in the second computing device, and then may be used in the second computing device.

FIG. 12 is a block diagram showing a hardware configuration of a computing device according to an embodiment of the present disclosure. Referring to FIG. 12, a computing device 500 may include one or more processors 510, a bus 530, a communication interface 540, a memory 520 that loads a computer program executed by the processor 510 therein, and a storage 550 that stores a computer program 560 therein. However, only components related to an embodiment of the present disclosure are illustrated in FIG. 12. Therefore, a person having ordinary skill in the art in the art to which the present disclosure pertains should understand that other general components than the components as illustrated in FIG. 12 may be included in the computing device. In other words, the computing device 500 may include various components in addition to the components as illustrated in FIG. 12. Furthermore, in some cases, the computing device 500 may be configured such that some of the components as illustrated in FIG. 12 are omitted. Hereinafter, each of the components of the computing device 500, according to an embodiment, is described.

The processor 510 may control all operations of the components of the computing device 500. The processor 510 may be configured to include at least one of a CPU (Central Processing Unit), an MPU (Micro Processor Unit), an MCU (Micro Controller Unit), a GPU (Graphics Processing Unit), or any further type of a processor well known in the technical field of the present disclosure. Furthermore, the processor 510 may perform computations of at least one application or program for executing operations/methods according to some embodiments of the present disclosure. The computing device 500 may have one or more processors.

The memory 520 may store therein various data, commands, and/or information. The memory 520 may load therein the computer program 560 from the storage 550 to execute operations/methods according to some embodiments of the present disclosure. The memory 520 may be embodied as a volatile memory such as RAM. However, the present disclosure is not limited thereto.

The bus 530 may provide a communication function between the components of the computing device 500. The bus 530 may be embodied as various types of buses such as an address bus, a data bus, and a control bus.

The communication interface 540 may support wired and wireless Internet communication of the computing device 500. Furthermore, the communication interface 540 may support various communication schemes other than Internet communication. To this end, the communication interface 540 may be configured to include a communication module well known in the technical field of the present disclosure.

The storage 550 may non-temporarily store therein one or more computer programs 560. The storage 550 may be configured to include a non-volatile memory such as Read Only Memory (ROM), Erasable Programmable (ROM EPROM), Electrically Erasable Programmable (ROM EEPROM), flash memory, a hard disk, a removable disk, or any form of computer-readable recording medium well known in the art to which the present disclosure belongs.

The computer program 560 may include one or more instructions that cause the processor 510 to perform the operations/methods according to various embodiments of the present disclosure when being loaded into the memory 520. The processor 510 may thus execute one or more loaded instructions to perform the operations/methods according to various embodiments of the present disclosure.

For example, the computer program 560 may include instructions for obtaining information about recently executed applications from a user device of a user having gotten into a mobility apparatus equipped with the navigation device, wherein the information about the recently executed applications includes execution order information about an order in which the recently executed applications have been executed in the user device; instructions for determining a display arrangement sequence of widgets of the recently executed applications on a display of the navigation device, based on the execution order information; and instructions for displaying the widgets in a first area of the display of the navigation device, based on the determined display arrangement sequence.

A variety of embodiments of the present disclosure and the effects according to embodiments thereof are described above with reference to FIGS. 1-12. The effects according to the technical idea of the present disclosure are not limited to the forementioned effects. Other unmentioned effects may be clearly understood by those having ordinary skill in the art from the description of the specification.

The technical features of the present disclosure described above may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained only when the operations are performed in the specific order or sequential order or when all of the operations are performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

Those having ordinary skill in the art should appreciate that many variations and modifications can be made to the described embodiments of the present disclosure without substantially departing from the principles of the present disclosure. Therefore, the described embodiments of the present disclosure are used in a generic and descriptive sense only and not for purposes of limitation.

What is claimed is:

1. A widget providing method performed in a navigation device, the widget providing method comprising:
obtaining information about recently executed applications from a user device of a user in a mobility apparatus equipped with the navigation device, wherein the information about the recently executed applications includes execution order information about an order in which the recently executed applications have been executed in the user device;
determining a display arrangement sequence of widgets of the recently executed applications on a display of the navigation device, based on the execution order information; and
displaying the widgets in a first area of the display of the navigation device, based on the determined display arrangement sequence,
wherein the first area is positioned at a position adjacent to a side of the display opposite to a driver seat of the mobility apparatus.

2. The widget providing method of claim 1, wherein displaying the widgets in the first area includes displaying a first-order widget at a left side of the first area or a right side of the first area, based on user sitting position information.

3. The widget providing method of claim 2, wherein displaying the widgets in the first area includes displaying the first-order widget at the left side of the first area, when the user sitting position information indicates that the user is sitting on the driver seat of the mobility apparatus.

4. The widget providing method of claim 2, wherein displaying the widgets in the first area includes displaying the first-order widget at the right side of the first area, when the user sitting position information indicates that the user is sitting on a passenger seat of the mobility apparatus.

5. The widget providing method of claim 1, wherein displaying the widgets in the first area includes adding a plurality of widgets respectively corresponding to a plurality of slots arranged in the first area to the plurality of slots.

6. The widget providing method of claim 1, wherein the first area includes at least one slot arranged in a horizontal direction.

7. The widget providing method of claim 1, further comprising:
obtaining situation information of the mobility apparatus; and
displaying widgets of recently executed applications associated with the situation information of the mobility apparatus in a second area different from the first area.

8. The widget providing method of claim 7, wherein the situation information of the mobility apparatus includes at least one of driving status information of the mobility apparatus, destination information of the mobility apparatus, position information of the mobility apparatus, status information of the mobility apparatus, or user sitting position information of the mobility apparatus.

9. The widget providing method of claim 7, wherein displaying the widgets in the second area includes:
obtaining frequency information on a frequency with which each of the recently executed applications associated with the situation information of the mobility apparatus has been executed in the user device; and
displaying the widgets of the recently executed applications associated with the situation information of the mobility apparatus in the second area, based on a display arrangement sequence determined based on the frequency information.

10. The widget providing method of claim 7, wherein the second area is positioned at a position adjacent to a side of the display adjacent to the driver seat of the mobility apparatus.

11. The widget providing method of claim 7, wherein the second area includes at least one slot arranged in a vertical direction.

12. A widget providing method performed in a navigation device, the widget providing method comprising:
obtaining information about recently executed applications from a user device of a user in a mobility apparatus equipped with navigation device, wherein the information about the recently executed applications includes execution frequency information on a frequency with which each of the recently executed applications has been executed in the user device;
determining a display arrangement sequence of widgets of the recently executed applications on a display of the navigation device, based on the execution frequency information; and
displaying the widgets in a first area of the display of the navigation device, based on the determined display arrangement sequence,
wherein the first area is positioned at a position adjacent to a side of the display opposite to a driver seat of the mobility apparatus.

13. A navigation device comprising:
a processor; and
a memory coupled to the processor, the memory configured to store instructions thereon,
wherein, when the instructions are executed by the processor, the instructions cause the processor to perform:
an operation of obtaining information about recently executed applications from a user device of a user in a mobility apparatus equipped with the navigation device, wherein the information about the recently executed applications includes execution order information about an order in which the recently executed applications have been executed in the user device;
an operation of determining a display arrangement sequence of widgets of the recently executed applications on a display of the navigation device, based on the execution order information; and
an operation of displaying the widgets in a first area of the display of the navigation device, based on the determined display arrangement sequence,
wherein the first area is positioned at a position adjacent to a side of the display opposite to a driver seat of the mobility apparatus.

14. The navigation device of claim 13, wherein the operation of displaying of the widgets in the first area includes an operation of displaying a first-order widget at a left side of the first area or a right side of the first area, based on user sitting position information.

15. The navigation device of claim 14, wherein the operation of displaying of the widgets in the first area includes an operation of displaying the first-order widget at the left side of the first area, when the user sitting position information indicates that the user is sitting on the driver seat of the mobility apparatus.

16. The navigation device of claim 14, wherein the operation of displaying of the widgets in the first area includes an operation of displaying the first-order widget at the right side of the first area, when the user sitting position information indicates that the user is sitting on a passenger seat of the mobility apparatus.

17. The navigation device of claim 13, wherein the operation of displaying of the widgets in the first area includes an operation of adding a plurality of widgets respectively corresponding to a plurality of slots arranged in the first area to the plurality of slots.

18. The navigation device of claim 13, wherein when the instructions are executed by the processor, the instructions further cause the processor to perform:
an operation of obtaining situation information of the mobility apparatus; and
an operation of displaying widgets of recently executed applications associated with the situation information of the mobility apparatus in a second area different from the first area.

19. The navigation device of claim 18, wherein the situation information of the mobility apparatus includes at least one of driving status information of the mobility apparatus, destination information of the mobility apparatus, position information of the mobility apparatus, status information of the mobility apparatus, or user sitting position information of the mobility apparatus.

20. The navigation device of claim 18, wherein the operation of displaying of the widgets in the second area includes:
an operation of obtaining frequency information on a frequency at which each of the recently executed applications associated with the situation information of the mobility apparatus has been executed in the user device; and
an operation of displaying the widgets of the recently executed applications associated with the situation information of the mobility apparatus in the second area, based on a display arrangement sequence determined based on the frequency information.
